(19) United States
(12) Patent Application Publication
(10) Pub. No.: US 2023/0368127 A1
(43) Pub. Date: Nov. 16, 2023

(54) KEEP IT MOVING SAFETY & COMPLIANCE APP

(71) Applicant: Kimberly L. Price, Dryer, IN (US)

(72) Inventor: Kimberly L Price, Dyer, IN (US)

(21) Appl. No.: 18/209,878

(22) Filed: Jun. 14, 2023

Related U.S. Application Data
(63) Continuation of application No. 16/501,483, filed on Jan. 27, 2020, now abandoned.

(51) Int. Cl. G06Q 10/083; G06Q 30/018; G06Q 10/0833

(52) U.S. Cl. CPC G06Q 10/0838; G06Q 30/018; G06Q 10/0833

(57) ABSTRACT

Provided are aspects for monitoring trucks and drivers. The system embodying the present invention is created is around the driver with a company regulation in mind for a company to be audited. Monitoring companies require recording accidents and instructions regarding further actions. These actions are taken during real time so the information is available to the company so they will be able to answer questions so later there is no mistaken about what has happened. The invention is embodied in an app which performs the required functions when activated.

### CROSS-REFERENCE TO RELATED APPLICATION

This application claims priority to U.S. application Ser. No. 16/501,483, titled “Keep It Moving Safety 7 Compliance App,” filed on Jan. 27, 2020, the entire disclosure of which is hereby incorporated by reference in its entirety.

### BACKGROUND OF THE DISCLOSURE

### 1. Technical Field

This disclosure relates to techniques for transportation management, and in particular, but without limitation, techniques for shipping and fleet management.

### 2. Description of the Related Art

Highways and roads are the backbone of the transportation system of most developed or developing countries. While other modes of transportation, such as aircraft, trains, and marine vessels may be used, highways and roads are generally pervasive and available to all citizens for use. As a result of the large network of highways and the locations that are reachable using them, trucking is one of the most often-used modes of transportation for shipping goods, materials for goods, etc.

Fleet vehicle operators have an interest in keeping track of the vehicles and shipments, for compliance with governmental regulations as well as monitor the performance and wellbeing of their drivers. Fleet vehicles may be equipped with devices that are configured to track the vehicles' geographic locations, speeds, headings, cargo, cargo temperature, engine performance parameters, and other data. Such information is used, for example, to maintain the vehicles, estimate delivery times, provide warning of possible damage to cargo, and to evaluate driver performance.

Collection of fleet vehicle information may also be useful to produce records for compliance with governmental regulations or company requirements. As examples, such records may include the number of miles a delivery vehicle has travelled since its last safety inspection and the number of hours a driver has been on duty since he or she last rested. This information was traditionally recorded on paper, e.g., driver logbooks, or in proprietary electronic formats. In either case, ensuring compliance with governmental regulations or company requirements may be time consuming and such information may be inconvenient to access or share with regulatory inspectors or other third parties.

One of the largest government-mandated paperwork and cost burdens imposed upon any segment of private industry are the reporting requirements relating to commercial motor vehicles (CMV). Commercial Motor Vehicles (CMV) and their respective drivers and carriers are required by various federal regulations and international agreements to comply with rules governing the safe operation of the vehicles and the reporting of fuel taxes. In 1937, the federal government-imposed hours-of-service (HOS) regulations upon commercial motor vehicle drivers operating commercial vehicles in the domestic motor carrier industry to ensure highway safety.

Under direction of Congress, the Federal Motor Carrier Safety Administration (FMCSA) has scrutinized and periodically revised the hours-of-service regulations to aid in the reduction of driver fatigue and sleep disorder related incidents on the nation's highways.

Federal regulations relating to the safe operation of Commercial Motor Vehicles (CMV) are defined in 49 CFR Part 395 and 49 CFR Part 390.2&.15, the entirety of each of which are incorporated by reference. One way in which safety is promoted in the hours-of-service regulations is to prohibit drivers from operating or being forced to operate their vehicles more than a specified amount of time between mandatory off-duty periods. In 1987, the FMCSA permitted carriers the flexibility of using an automatic on-board recording device (AOBRD) instead of the traditional reporting method involving manual data entry and filing of reports by the CMV drivers and/or their carriers.

The International Fuel Tax Agreement (IFTA) is an agreement among jurisdictions in the United States, Mexico and Canada that simplifies the reporting of fuel-use tax for diesel, gasoline, gasohol, propane, and natural gas consumption by commercial motor vehicles. Fuel use tax is included in the purchase price of the fuel and then later redistributed to those jurisdictions where the vehicle was driven while consuming fuel. For example, a driver of a CMV may purchase diesel fuel in the state of

Texas and travel outside of Texas to a neighboring state, e.g., Louisiana, using the same diesel fuel purchased in Texas. IFTA requires carriers to report actual mileage driven in each jurisdiction so that the actual taxes collected may be later apportioned to Texas and Louisiana in accordance with actual vehicle operation. Each day, some 6.4 million drivers complete HOS logs to track driver compliance with HOS regulations. In addition, fuel tax logs are created daily for some 10 million trucks. The cost of compliance with these reporting requirements is extraordinarily burdensome. It is estimated that the annual cost of complying with reporting requirements using paper logs is approximately $2,000.00 per driver and $2,000.00 per commercial motor vehicle. This results in a paper log compliance cost of $31 billion dollars per year imposed upon private industry. Transportation companies spend an average of $15,000 dollars a year with driver turnover. Between the driver screening, corporate fillings, service background checks, MVR Monitoring [Live, and the like, these companies spend an inordinate amount of time and money on such mundane occurrences as these. Something as simple as a child support payment revokes a driver's cdl. If a driver gets pulled over for any reason, then it is a ding on the company for being incompetent and could result in a $5000 fine. Drug and Alcohol programs FMCSA demand that the owners of companies to be accountable for every move. The brokers want to be able to track certain shipments for the customers.

If a company is audited, owners end up paying around an average of $9000 which is about $180 an hour for a person to represent them and complete the audit. The aftermath after is even higher to fix. The company will be required to hire a safety compliance company to monitor everything and fix issues.

Every time a driver starts a new job they have to go through the same thing over and 3 jurisdictions where the vehicle actually was driven while consuming fuel. For example, a driver of a CMV may purchase diesel fuel in the state of Texas and travel outside of Texas to a neighboring state, e.g., Louisiana, using the same diesel fuel purchased in Texas. IFTA requires carriers to report actual mileage driven in each jurisdiction so that the actual taxes collected may be later apportioned to Texas and Louisiana in accordance with actual vehicle operation. Each day, some 6.4 million drivers complete HOS logs to track driver compliance with HOS regulations. In addition, fuel tax logs are created daily for some 10 million trucks. The cost of compliance with these reporting requirements is extraordinarily burdensome. It is estimated that the annual cost of complying with reporting requirements using paper logs is approximately $2,000.00 per driver and $2,000.00 per commercial motor vehicle. This results in a paper log compliance cost of $31 billion dollars per year imposed upon private industry.

Transportation companies spend an average of$15,000 dollars a year with driver turnover.

Between the driver screening, corporate fillings, service background checks, MVR Monitoring/Live, and the like, these companies spend an inordinate amount of time and money on such mundane occurrences as these. Something as simple as a child support payment revokes a driver's cdl. If a driver gets pulled over for any reason, then it is a ding on the company for being incompetent and could result in a $5000 fine. Drug and Alcohol programs FMCSA demand that the owners of companies to be accountable for every move. The brokers want to be able to track certain shipments for the customers.

If a company is audited, owners end up paying around an average of $9000 which is about $180 an hour for a person to represent them and complete the audit. The aftermath after is even higher to fix. The company will be required to hire a safety compliance company to monitor everything and fix issues.

Every time a driver starts a new job they have to go through the same thing over and over. 90% of the time, the driver does not remember start and finish dates

and hiring company contacts for new employer. Or, if they get in trouble no matter what state, they must find a lawyer to help them.

Therefore, there is a need for a means to track and record shipments as well as driver profiles. It is an object of the present invention to provide such as system.

Improvements on the foregoing are desired.

### SUMMARY

The system embodying the present invention is created is around the driver with a company regulation in mind for a company to be audited. Monitoring companies require recording accidents and instructions regarding further actions. These actions are taken during real time so the information is available to the company so they will be able to answer questions so later there is no mistaken about what has happened. The invention is embodied in an app which performs the required functions when activated.

### BRIEF DESCRIPTION OF THE DRAWINGS

Phone Application With all Screens

Logo

### DETAILED DESCRIPTION

391.23 and 49 CFR
Inquiry To State Agencies for 3-Year Driving Record—49 CFR 391.23(a)(1) and (b) Pre-
Employment Drug and Alcohol Documents—49 CFR 40.250; 49 CFR 382.301 Multiple Employer Drivers—49 CFR 391.63

Uploads
A Driver Application Electronic APP
Every time a driver goes to a company he can update information that can be put into a cloud downloadable to a cloud account this will make all information up to date This application would include a copy of MVR, Med Card, COL
Emergency Contact Information
Point of contact Information: Doctor Information Med information
Violation Ticket Category:
Anytime driver gets a Violation ticket warning he just has to take a picture of it and download in to NS Cloud Inspections
At! inspections can be put into file with bad inspections with maintenance errors will have the receipt with the inspection as well as eki 10 for that day
(4396.11, 396.13, and 396.17 are in addition to the systematic inspection, repair, and maintenance required by 6396.3). Accident register All the information will be able to be put into his system
This keeps the driver up to date on his losses and is easily obtainable for insurance companies to assist in getting them approved for new company hires
Owner Operators and drivers have a place to upload all their maintenance files and receipts
6
ELD Built in for previous work so they do not have to keep learning different systems, adding different apps different sign ins and the last i4 days are already logged so when auditor comes in there are no questions about the accuracy of hours
Company sign on and sign offs on employment Insurance on file (Owner operators) Place for them to have their filling on file 2290, ucr, insurance—no more having to call a hundred different people to obtain the Information saves time and money.
Point of contact Information: Doctor Information: Med information

The Idea is to develop an iOS, android and web to allow customer to post load by providing basic details. Customer can post booking request amount and company can send request to work on customer job after customer acceptance it will assigned to company.

Company are the end user who can take subscription to website. He/she need to pay subscription fee Monthly/yearly to keep using the website. Company will be allowed to add Truck and Driver. Once load is assigned to Truck owner, truck owner will be assigning it to Driver.

Customer and Truck owner both will be allowed to track booking.

Admin user will be allowed to perform following tasks through the admin dashboard.
Customer Management—Admin will be allow to view registered users and their details.
Driver Management—Admin will be allowed to view registered driver.
Truck Owner Management—Admin will be allowed to view registered truck owner and their details.
Booking Management—Admin can view all the scheduled booking and past booking.
Transaction Management—Admin will be allowed to view all transaction history.
Subscription Fee Management—Admin will be allowed to manage the subscription fee, He/she can add/edit subscription fee.
Directory Management: Admin will be allowed to add/edit contact number in directory.

What invention does and how it does it. There would be basically three types of user in system.
Customer—Customer are the end users who will be allowed to create profile and can request for booking.

Company is the end user who will be allowed to create profile by taking subscription and will be allowed to bid on load and to track drivers.
Driver—Drivers are the end user whose account will be created by Truck owner. Drier will work on job as per assigned by truck owner.
Admin—Administrator/Admin user will have full control over the application. She/he shall manage Truck owner, customer, driver, booking, and content management system. Shall also be able to deactivate/activate the users, Full access to view list/find users.

Technology Stack

The system shall be developed using following technologies to develop App. Backend (Admin & AP/) iOS & Android (Portrait and Online Support Framework: PHP (Laravel)
Database: MySQL
Scripting Language: JavaScript Theme: Bootstrap Ionic: 3
iOS & Android (Portrait and Online Support
Device Database: SQLite
IDE: Ionic Studio
Device Support: iPhone 6 and later No iPad, Android 5.0 to 9.0
4. Target Regions & Languages
Global/Multi language/English

Driver Briefcase
49 CFR 391.25 (a) and (c) Review of Driving Record—Annual—49 CFR 391.25 (c) (2) Driver's Certification of Violations—Annual—49 CFR 391.27 Medical Examination Report and Medical Examiner's Certificate—49 CFR 391.43 Employer note verifying that medical examiner is listed on National Registry of:
Certified Medical Examiners—Non-COL drivers: 49 CFR 391.51(b)(9)(i)); COL drivers: 49 CFR 391.51(b)(9)(ii)) Driver's Application for Employment—49 CFR 391.21
Safety Performance History Records: Driver Correction or Rebuttal (if applicable)—49 CFR 391.23(i)(2) and 49 CFR 391.23(j)(3))
Inquiry To State Agencies for 3-Year Driving Record—49 CFR 391.23(a)(1) and (b) Pre-Employment Drug and Alcohol Documents—49 CFR 40.25(j); 49 CFR 382.301 Multiple-Employer Drivers—49 CFR 391.63

Uploads

A Driver Application electronic APP

Every time a driver goes to a company he can update information that can be put into a cloud downloadable to a cloud account this will make all information up to date This application would include a copy of MVR, Med Card, CDL

(drivers hate having to fill out application every time its like pulling teeth)

Emergency Contact Information
Point of contact information: Doctor Info:
Med info

Violation Ticket Category

Anytime driver gets a Violation ticket warning he just has to take a picture of it and download into his Cloud.

Inspections

All inspections can be put into file with bad inspections with maintained errors will have the receipt with the inspection as well as eld lo for that day (§ 396.11, 396.13, and 396.17 are in addition to the systematic inspection, repair, and maintenance required by § 396.3.)

Accident Register

All the information will be able to be put into his system.

This keeps the driver up to date on his losses and is easily obtainable for insurance companies to assist in getting them approved for new company hires.

Owner Operators and drivers have a place to upload all their maintained files and receipts ELD/abroad Built in for previous work so they do not have to keep learning different systems, adding different apps different sign ins and the last 14 days are already logged so when auditor comes in there are no questions about the accuracy of hours Company sign on and sign offs on employment.

Insurance on File

(Owner Operators)
Company Side/owner operator DOT Regulations Maintain audit
Desktop Windows Client
1.4 GHz Intel© Pentium© 4 or faster processor (or equivalent) for Microsoft© Windows© XP or Windows 7; 2 GHz Pentium 4 or faster processor (or equivalent) for Windows Vista©
Windows XP, Windows Vista, Windows 7, Windows 8, or Windows 10
1 GB of RAM (2 GB recommended) for Windows XP; 2 GB of RAM (4 GB recommended) for Windows
7/Vista, Windows 8 or Windows 10. 50 MB of hard drive space
Windows Server
2 GHz Intel© Pentium© 4 or faster processor (or equivalent) Windows XP, Windows Vista, Windows 7, Windows 8, Windows 10. Windows 2003, or
Windows Server 2008-2016
2 GB of RAM (4 GB recommended)

Safety Management Cycle for the Vehicle
Maintenance BASIC—Inspection-Repair-Maintenance
5.2.1 Records
Records of all inspections, repairs, and maintenance must be retained. According to 49 CFR 396.3, required records include the following:
Identifying information of the vehicle, including company number, make, serial number, year, and tire size; (See also, Marking of Self-Propelled CMVs and Intermodal Equipment.)

A schedule highlighting the type and due date of inspections and maintenance to be performed; and Inspection, repair, and maintenance records indicating the date and nature of each.

Inspection, repair, and maintenance records indicating the date and nature of each. Carriers must maintain records for each vehicle they control through ownership or lease for 30 consecutive days. These records must be retained for one year at the location where the vehicle is housed or maintained. These records must be retained for six months after the vehicle leaves the carrier's control (sale, trade-in, etc.).

Passenger carriers must keep records of tests conducted on emergency doors, emergency door marking lights, and pushout windows,

The SMC is used to systematically assess SMPs in six areas:
1. Policies and Procedures, 2. Roles and Responsibilities,
3. Qualification and Hiring, 4. Training and Communication,
5. Monitoring and Tracking, and 6. Meaningful Action. By periodically reviewing each process, there is an opportunity to identify and correct breakdowns in SMPs before safety and compliance issues are identified or crashes occur. The SMC can also be used after safety and compliance issues or crashes have taken place to assist in determining which SMPs need attention.

The SMCs for each BASIC can be found in the Information Center on the SMS Website at http://ai.fmcsa.dot.gov/sms Policies and Procedures
Develop a system of preventive maintenance for compliant, safe, and efficient fleet operations, including a schedule for periodic maintenance, inspection, and recordkeeping. This system should be attuned to manufacturer recommendations, the carrier's own experience, and regulatory requirements.
Develop a procedure ensuring that vehicle defects that impact safety and/or safety compliance are reported, repaired, and certified before the vehicle is operated.
Develop procedures to ensure that management is notified of vehicle defects through the use of Driver Vehicle Inspection Records (DVIRS) and other communication channels, such as driver call-in and e-mail from mechanics.
Develop a policy ensuring that drivers are qualified to complete thorough and timely DVIRs by the end of the day of the trip and prior to a subsequent assignment.
Establish a policy requiring drivers to submit copies of all roadside inspections to carrier management within 24 hours.
Develop policies and procedures requiring drivers to immediately notify appropriate management of any roadside vehicle Out-of-Service Order (0050).
Develop a written and progressive disciplinary policy focused on taking corrective action to ensure drivers comply with regulations and policies. A progressive disciplinary policy could include, among other things, written warnings,
suspensions, or work restrictions, monetary penalties, and termination. This policy should also specify consequences for any carrier official who knowingly and willfully allows vehicle maintenance violations.

Passenger Carrier Only:
Develop systematic procedures for inspecting maintenance items critical to fire safety and emergency evacuation—for example, checking wheel-hub lubrication levels according to the manufacturer's recommended inspection intervals, checking wheels for signs of excess heat every time the motor coach is parked, regularly inspecting wiring and electrical systems for short circuits, and inspecting emergency exit operation and markings.
Consider installation of fire detection and suppression systems on current fleets and as purchase options on new coaches. Roles and Responsibilities Define and document responsibilities of managers, supervisors, drivers, dispatchers, mechanics, and technicians as related to vehicle inspection, repair, and maintenance policies, including the monitoring and documentation of defects and repairs.
Define and document roles and responsibilities of mechanics and technicians for differentiating between safety-related defects and other defects and for taking unsafe vehicles out-of-service (OOS).
Empower the person who is in charge of fixing trucks with the authority to complete tasks, such as the purchasing of new parts when needed.
Define and document roles and responsibilities for checking daily completion of DVIRs and certifying repair before the next assignment.
Define and document dispatcher responsibilities for planning, scheduling, monitoring, and adjusting fleet operations in accordance with repair and maintenance requirements.
Define driver responsibilities for informing managers, supervisors, and mechanics/technicians of safety-related defects and repair requirements prior to vehicle operation, including those resulting from vehicle OOSOs.

Passenger Carrier Only:
Designate a manager to collect and evaluate all vehicle inspection-, repair-, and maintenance related customer complaints and their safety implications. Qualification and Hiring Ensure that prospective employees are qualified to inspect, repair, and maintain the carrier's vehicles by querying applicants, checking with previous employers and references, and obtaining necessary documents regarding inspection, repair, and maintenance responsibilities and (for mechanics and technicians) the quality of previous work, including whether maintenance services were systematic and well documented. Create a detailed written record of each inquiry.
Query the FMCSA information systems to check the vehicle inspection, repair, and maintenance performance (violations, 005 rates, etc.) of other carriers for whom the mechanic has worked. Then, ask follow-up questions to better determine the mechanics performance in those previous jobs. U.S. Department of Transportation Federal Motor Carrier Safety Administration HTTP://CSA.FMCSA.DOT.GOV/JANUARY 2013 3 FMC-CSA-13-005 Safety Management Cycle for the Vehicle Maintenance BASIC—Inspection-Repair-Maintenance Verify prospective brake inspectors' understanding of job requirements and their applicable training and apprenticeship credentials.
Screen prospective dispatchers for flexibility and the ability to deal with crisis by posing “what if” scenarios, such as how they would expedite an emergency repair or a replacement vehicle if given an 005 call on a critical haul.
Assess prospective drivers' understanding of their responsibility for, and experience with, inspecting and maintaining the vehicle, reporting defects, and verifying repairs. Ensure that the employment application captures all information required by Federal Motor Carrier Safety Regulations. (FMCSRs)—for example, for drivers, with regard to types of vehicles operated, and for mechanics and technicians, with regard to certification of the ability to perform repairs. Enhance the recruitment process to identify and attract qualified applicants for the positions of safety director, mechanic, and other roles with responsibility for inspection, repair, and maintenance, using outside resources such as insurance companies, industry groups, and consultants for employee searches and referrals.

Passenger Carrier Only:
Verify that mechanics and technicians are familiar with advanced technology and are certified for the vehicles on which they will be working. Training and Communication convey expectations to all applicable staff for adhering to vehicle inspection, repairing, and maintenance regulations and company policies and procedures, and for executing responsibilities by providing new hire and refresher training, and establish communication channels such as newsletters and/or meetings focused on conflicts between vehicle availability and repair requirements.
Ensure that all employees understand and accept their responsibility for timely communication of safety issues related to fleet inspection, repair, and maintenance to the appropriate individuals. Ensure that managers and supervisors articulate their commitment to and establish communication with employees concerning vehicle inspection, repair, and maintenance.
Communicate the carrier's Vehicle Maintenance BASIC percentile to all staff and explain to them individually what they can do to help improve compliance.
Ensure that mechanics and technicians communicate with the vehicle and equipment manufacturers and receive regular updated bulletins and recommendations.
Ensure that carriers with non-English-speaking employees who need to communicate with English-speaking employees and to understand English language literature, such as the manufacturer's guide, have ways to deal successfully with language barriers.
Ensure that all drivers, dispatchers, managers, mechanics, and technicians receive training, including methods and tools, and appropriate certifications to fulfill their responsibilities and documentation requirements regarding vehicle inspection, repair, and maintenance, as required by regulations and company policies.
Implement and provide training for a fleet maintenance software system that can be updated according to current industry and regulatory standards, manufacturer's recommendations, and the carrier's experience.
Train mechanics to be able to differentiate between safety related defects and other defects—for example, by recognizing that defective wheel ends can lead to wheel separation.

U.S. Department of Transportation
Federal Motor Carrier Safety Administration HTTP://CSA.FMCSA.DOT.GOV/JANUARY 2013 4 FMC-CSA-13-005
Safety Management Cycle for the Vehicle Maintenance BASIC—Inspection-Repair-Maintenance Ensure that drivers are trained in vehicle 005 rules, their responsibilities in adhering to them, and the carrier's procedures for reporting 005 violations and communicating appropriately with other personnel.
Train all staff who are required to monitor and track vehicle maintenance on the appropriate company policies, including those related to discipline and incentives. Provide hiring officials with guidance on how best to attract, screen, and qualify applicants who are most likely to adhere to vehicle inspection, repairing, and maintenance regulations and company policies and procedures.
Reinforce training to drivers, mechanics, and other employees about vehicle maintenance policies, procedures, and responsibilities, using job aids, post-training testing, and/or refresher training. Encourage informal feedback among drivers and mechanics so that they can help each other to improve.

Passenger Carrier Only:
Provide training on procedures related to fire safety and emergency evacuation, such as checking wheel-hub lubrication levels according to the manufacturer's recommended inspection intervals, checking wheels for signs of excess heat every time the motor coach is parked, regularly inspecting wiring and electrical systems for short circuits, and inspecting emergency exit operation and markings. Monitoring and Tracking Check all inspections and relevant records, such as DVIRs, pretrip and annual inspections, and maintenance and repair records, to ensure that company inspection, repairing, and maintenance policies and procedures are adhered to and properly documented.
Ensure that DVIRs are effectively coordinated with maintenance and operations, result in timely corrective measures, and are verified during pre-trip inspections as applicable.
Require mechanics to note whether parts came from inventory or were ordered, to ensure accuracy of maintenance records.
Monitor and track roadside inspection results to ensure that vehicle defects are repaired and documented promptly and to prevent 005 vehicles from operating prior to being repaired. Monitor manufacturer recalls through www.nhtsa.dot.gov and consult with manufacturer service representatives to keep current with service bulletins for proactive maintenance.
Implement a system for keeping accurate records of employee inspection, repair, and maintenance training needs, including updates on a carrier's fleet or equipment and completed training, via software, a checklist in the driver's file, and/or another appropriate method.
Regularly evaluate the company's vehicle-maintenance-related inspection results via FMCSA's Website at http://ai.fmcsa.dot.gov/SMS. Assess violations for process breakdowns and how to remedy them. Maintain inspection, repair, maintenance, vehicle identification, and communication records to help evaluate the performance of all staff (drivers, dispatchers, mechanics, and managers) involved in fleet maintenance and the effectiveness of compliance with vehicle maintenance policies, procedures, and regulations. Evaluate personnel who are monitoring vehicle maintenance performance by making sure they are using DVIRS, roadside inspections, and other data; applying performance standards fairly, consistently, and equitably; and documenting evaluations.

When monitoring and tracking vehicle maintenance issues, always assess whether an issue is individual or represents a systemic breakdown in one of the SMPs (Policies and Procedures, Roles and Responsibilities, etc.).

U.S. Department of Transportation
Federal Motor Carrier Safety Administration HTTP://CSA.FMCSA.DOT.GOV/JANUARY 2013 5 FMC-CSA-13-005
Safety Management Cycle for the Vehicle Maintenance BASIC—Inspection Repair-Maintenance

Passenger Carrier Only
Monitor manufacturer recalls through www.nhtsa.dot.gov; consult with manufacturer service representatives to keep current with service bulletins for proactive maintenance, especially with regard to preowned buses.
Monitor and track vehicle-maintenance-related passenger complaints and assess safety implications. Meaningful Action Design and implement incentives and/or recognition programs in order to reward and encourage effective performance related to compliance with vehicle inspection, repair, and maintenance regulations and company policies—for example, to include bonuses, gift certificates, and/or verbal recognition to drivers for a clean Level 1 inspection report.
Give employees immediate feedback, and require corrective action as soon as the company is aware that vehicle inspection, repair, and maintenance responsibilities are not being fulfilled.
Provide remedial training to employees with performance issues related to vehicle inspection, repair, and maintenance that can be addressed by enhancing their knowledge and skills.
Implement a disciplinary policy where potential disciplinary measures correspond to risk posed, with violations associated with high-consequence accidents or incidents being punished more severely.
Discipline carrier officials for knowingly and willfully allowing violations of vehicle inspection-, repair-, and maintenance related regulations, such as allowing a driver to use a truck that is in disrepair.

If the problem related to vehicle maintenance is systemic, make adjustments to one or more of the SMPs (Policies and Procedures, Roles and Responsibilities, etc.).

Sample of Info
Driver's Vehicle Inspection Report Check ANY Defective Item and Give Details under “Remarks.” DATE: ______ TRuCk/TRACTOR
NO. ______ Air Compressor Air Lines □□ Horn Lights Battery Head—Stop Brake Accessories Tail—Dash
Brakes Turn Indicators □□ Springs Starter Steering
Tachograph Tires Transmission Wheels Windows Windshield Wipers Other Carburetor Clutch
Defroster Drive Line Engine Fifth Wheel Front Axle Fuel
Tanks □□ Mirrors Muffer Oil Pressure On-Board Recorder
Radiator Rear End Reflectors Safety Equipment Heater Fire Extinguisher
Flags—Flares—Fuses Spare Bulbs & Fuses Spare Seal Beam TRAILER(S) NO
(S). ______ □□ Brake Connections Brakes Coupling Chains Coupling (king) Pin Doors Hitch Landing Gear Lights—All Roof □□□□ Tarpaulin Tires
Wheels Other Springs Remarks:
______
______ □□□ Condition of the above vehicle is satisfactory Driver's Signature
______ Above Defects Corrected Above Defects Need NOT Be Corrected For Safe Operation Of Vehicle Mechanic's Signature
Date ______
Drivers Signature ______
Date ______
VEHICLE INSPECTION, REPAIR, AND MAINTENANCE RECORD
VEHICLE/IDENTIFICATION
MAKE VIN
MODEL YEAR TIRE SIZE
COMPANY NUMBER OWNER (IF LEASED)
INSPECTION, REPAIR, MAINTENANCE INFORMATION
I R M DATE
(MM/DD/YY)
MILEAGE TYPE NEXT DUE SERVICE
(DATE OR MILEAGE)
I=INSPECTION; R=REPAIR; M=MAINTENANCE
NOTE: FOR BUSES, PUSHOUT WINDOWS, EMERGENCY EXITS, AND EXIT LIGHTING MUST BE INSPECTED EVERY 90 DAYS.
TRUCK/TRAILER INFORMATION INTERCHANGE
SWITCH INFO TO CORRECT TRUCK/TRAILER COMBINATION
PERMITTING
PERMITTING SPECIAL HEAVY HAUL
WEEKLY/DAILY/SHORT TERM RESTRICTION UPDATE FOR ANNUAL PERMIT HOLDERS
STATE WIDE RESTRICTIONS
DRIVER-RELATED DOCUMENTS DRIVERS LIST
DRIVER'S LICENSE
DRIVER'S RECORDS OF DUTY
(ROD) AND SUPPORTING DOCUMENTATION
DRIVER'S MOTOR VEHICLE RECORD (MVR)
MEDICAL CERTIFICATE
VEHICLE-RELATED DOCUMENTS
VEHICLE LIST
VEHICLE INSPECTION
HAZARDOUS MATERIALS (HM)
SHIPPING PAPERS
CARRIER/PROGRAMMATIC RELATED DOCUMENTS
PROOF OF INSURANCE
DRUG & ALCOHOL PROGRAM
ACCIDENT REGISTER

Driver

1. Drivers List

All carriers must provide a list of currently employed drivers. This list is used to assess applicability of

Various regulations, and should include: each driver's first and last name, date of birth, date of hire, license number, and license state.

### EXAMPLES

Last name; first name; date of birth; date of hire; license number; license state
I.E., SMITH JANE May 12, 1968 Feb. 20, 2005 5530-4406-8736 IL JOHNSON WILBUR Dec. 20, 1985 Jul. 18, 2009 J525-8808-5361 IL OR;
NAME, DATE OF BIRTH, LICENSE NUMBER, LICENSE STATE, DATE OF HIRE
I.E., JANE SMITH, May 12, 1968, 5530-4406-8736, IL, Feb. 20, 2005
I.E., WILBUR JOHNSON, Dec. 20, 1985, J525-8808-5361, IL, Jul. 18, 2009

2. Driver's License

All commercial motor vehicle (CMV) drivers must be appropriately licensed to drive the specific type of vehicles they operate, appropriate licenses are either an operator's license issued by one state or jurisdiction, a commercial driver's license (CDL) (with proper endorsements as necessary), a Canadian License or a license as federales de conductor issued by the Mexican government. In order to obtain any of these licenses, drivers must have passed a knowledge and skills test for the appropriate type of vehicle.

An operator's license is required for drivers of CMVS that:
Have a gross vehicle weight rating (GVWR) or gross combination weight rating (GCWR) of 10,000-26,000 Lbs (including towing vehicle)
Transport 8-15 passengers (including the driver) for compensation (for-hire) (see FMCSR general regulation definitions and guidance for more information)

Exceptions
Farm vehicles and their drivers when the vehicle is:
Controlled and operated by a farmer as a private motor carrier of property being used to transport either agricultural products or farm
Machinery and/or supplies to or from a farm
Not being used in the operation of a for-hire carrier not carrying placardable hm
Being used within 150 air miles of the farm
Vehicle controlled by a beekeeper engaged in seasonal transportation of bees school buses, federal/state operations, property moved not for commerce, carrying corpses, ambulances, fire trucks responding to an emergency, 9-15 passengers private vehicles, propane, winter
Heating fuel

A COL is required for drivers of CMVS that:
Have a GVWR or GCWR of 26,001 lbs or more (including towed trailers/vehicles) transport 16 or more passengers (including the driver) either for compensation (for-hire) or not for compensation (private)
Transport placardable amounts of hazardous materials (see 49 CFR Part 172
Subpart f) (see FMCSR general regulation definitions and guidance for col for more information)

In addition, drivers of certain vehicles requiring a col must pass additional tests to obtain an appropriate endorsement as explained on FMCSA's commercial driver's license web page.

Exceptions
Military drivers operating a cmv for military purposes farm vehicle drivers where the vehicle is:
Controlled and operated by a farmer as a private motor carrier of property being used to transport either agricultural products or farm
Machinery and/or supplies to or from a farm
Not being used in the operation of a for-hire carrier not carrying placardable hm
Being used within 150 air miles of the farm
Firefighters, emergency response vehicle drivers, and drivers
Removing snow and ice laws/regulations
Federal motor carrier safety regulation part 383, commercial driver's license standards;

Requirements and Penalties
Federal motor carrier safety regulation part 391 subpart b (391.11-391.15), qualifications and disqualifications of drivers additional resources
Commercial driver's license program (CDL/CDLIS) 3
Driver's records of duty (rod) & supporting documentation
Every motor carrier must require every driver to record his/her duty status for each 24-hour period

Using specific methods outlined by regulation. Logs/records of duty status (rods) must be kept current by showing each change in duty status. The time zone used on a driver's daily log should be the time standard of that driver's home terminal. For each change in duty status, the name of the City/town/village with the state abbreviations must be recorded. In addition to the status of the driver, specific information must be included as outlined in 395.8. During a safety audit, motor carriers may be asked to submit documents supporting the driver's record of duty. Such documents can include any of the following: toll receipts/records, fuel receipts/records, bills of lading, trip reports or another type of document for verification.

Beginning Dec. 18, 2017, motor carriers subject to the eld rule must automatically record on and off-duty time using an electronic

Logging device (ELD). Motor carriers who have an automatic onboard recording device (AOBRD) that was installed and in-use prior to Dec. 18, 2017, may continue to use this device to record and share hos data until Dec. 16, 2019. Requirements for elds can be found in 49 CFR 395 subpart b. requirements for automatic onboard recording devices can be found in 49 CFR 395.15.

Federal audit submission code/or key for auditor to submit your eld file:
Via web-service (telematics or Bluetooth): eld device will prompt user to request an “output file comment.” the comment you enter must be news-xxxxx where the x's represent a unique identifier that will be provided to you upon the start of your audit.
Via local data transfer: eld device will output a file that user can upload to news via the upload button. Do not print and fax in this file; it must be uploaded. To submit your AOBRD file: Upload or fax your file to news using the “upload here” button at the top right of this page.
THIS SYSTEM HAS ALL SIDES IN MIND
UPGRADES ARE AVAILABLE
SUCH AS
1/LAWYER OUTREACH

Company or driver they have number to call whatever their needs may be so they can keep it moving.

Able to file 22905/UCR/RENEWALS/FTA/AT THE PUSH OF A BUTTON
Accounting Services—Platform for driver or owner operator no more taking time off to do it.
Insurance quotes—platform information is already in their system data Q sign in and dispute roadside

Dispatchers will no longer have to look up and make calls, they only have to approve.

Roadside Assistance

Pinging truck and finding closest facility to fit their needs. Driver can find what he needs get price send to company with a approval or denial button. No more let me

Ask this person or that person. Owner operators are accountable for and responsible for fixing the truck but same concept for drivers under them appendix below is a list of sample documentation referenced in this guide. Driver's records of duty (rods) and supporting documentation driver's motor vehicle record:
Medical certificate vehicle list
Vehicle inspection report
Hazardous materials (hm) shipping papers proof of insurance
Alcohol testing form drug testing form accident register
Search results web results [pdf]
Safety audit resource guide—us department of transportation
Different types of audits incurred for the information sample per regulation:
Types of dot audits &
Required documentation
Compliance review security hazardous materials new entrant
Shipping documents x1 x1 x1 x2
Driver qualification x1 x1 x1 x2 hours of service x1 x1 x1 x2
Driver & maintenance x1 x1 x1 x2 x2
Accident register x1 x1 x1 x2 placarding x1 x1 x2
Hazmat registration x1 x1 x2
Drug testing program x1 x2
Security plan x1 x1 x1 x2
Financial plan x1 x1 x1 x2
Operations review x1 x1 x1 x2
   Full audit verifying historical, current and systematic compliance.
   Small sample to demonstrate understanding of compliance. Compliance review checklist
Confidential information needed for compliance review (see attached). Office records
Drug and alcohol company policy and testing records
Site specific security plan with assessment (drivers should sign and update annually)
Driver qualification files which include the following requirements found in the code of federal
Regulations, sections 382.401, 40.333 and 391.53: application for employment fair credit reporting statement
Request for check of driving record (every year) request for information—previous employers
Request and consent from previous employers on drug and alcohol testing driver's safety performance history
Road test (performed by certified col holder)
Medical examination report (every 2 years) or waiver (if applicable) driver's certificate of violations/annual COV
Annual review of driving record
Driver's certificate of driver's license driver's receipt—driver's handbook driver's receipt—drug and alcohol policy
Drug test—pre-employment and random copy of current driver license
Copy of current medical card
Hazardous materials (hazmat) endorsement and test (if applicable) driver's mandatory notification of violations (out of state violations)
Inquiries to state agencies company policies
Alcohol and substance abuse policies driver's handbook and policy
Driver's handbook, towing and recovery policy (if applicable) company's security plan
False logs policy
List of active employees and their hire date proof of insurance (msc-90) driver logs or time cards for past 6 months
Driver's vehicle inspection records (driver) for past 6 months vehicle maintenance files showing vehicle/identification, maintenance schedule and photos,
Unit number, tire size, yin number, make, model and year vehicle annual inspections—14 months or 2 reports from last inspection
Cargo tank records including manufacturer's certificate of origin (“birth certificate”), tank test
And inspection paperwork
Hazmat driver training records and program
USDOT hazmat registration
(Http://hazmat.dot.gov/regs/register/register.htm) driver's log or time sheets for the 100 mile exemption paperwork for annual vehicle inspections.
Keep duplicates of everything required to be in vehicle in the office! Accident register—maintain for at least 3 years from date of accident
Hazmat companies information (if applicable). Make sure all certifications and rectifications are current.
Federal hazardous registration
Hm-126 training test and certificate (driver's and office personnel) every 2 years hm-232 driver security training and certificate and re-certification every 2 years vehicle—visual, annual tank test records
Quarterly drug and alcohol consortium test results propane companies—all hazmat information plus:
Hm225a training for each driver
Monthly hose inspections (minimum 12 months) vehicle—visual, annual tank test records
Unique hose identification numbers on all hoses remote shutoff testing at 150 feet away every morning
Dot certificate of compliance for each bobtail and pipe drawing inside vehicle proper shipping papers with emergency response information
Emergency response telephone number hazmat registration driver's daily vehicle inspection report (driver)
Driver's daily log book (DDL) or elog access vehicle registration & proof of insurance proof of for-hire authority, if applicable
Proof of annual vehicle inspection (windshield sticker)
10 BC fire extinguisher spare fuses
Bl-directional reflective triangles on the vehicle
USDOT number
Company name, city and state on doors (large enough to read 50′ away) legible placards on all four sides of the vehicle
Correct markings (id numbers)
On the cargo tank, up to date testing marks. Specification plate if you haul gasoline.
In the driver's possession (wallet)
A current col with appropriate endorsements
Current medical certificate trip information including: trip number
Shipping documents bills of lading
Hours of service logs
Daily inspection reports (signed)
Emergency contact names and phone numbers hos visor card

It is very important that each and every person in the company adhere to the guidelines, rules and regulations as set forth by FMCSA and DOT. Continuing the effort to remain compliant will go a long way if and when a dot safety audit is encountered.

The greater the preparation, the more likely your company is to pass an audit. It's much better to take the time to ensure your documentation is complete and up to date before you are caught off guard.

The fines that dot are now able to impose are much greater and not worth it!

Properly training each member of your organization will help everyone stay on top of compliance.
Confidential information needed for compliance review date: ______
Full corporate name:
Principle office address:
Mailing address:
State and date of incorporation:
Telephone number:
Telephone number:
Federal taxpayer 1.0. Number:
ICC/mc number:
USDOT number:
gross revenue preceding year: $
Ending fiscal year date:
Officers of corporation (name and title)
Other office locations: (use reverse side if needed)
Total commercial miles driven (previous year):
Equipment owned leased number of trucks ______
Number of tractors number of trailers ______
Number of hm cargo tank trucks ______
Total number of drivers: total number of col drivers: ______

Features
Eld compliance GPS tracking smart dash cam IFTA fuel tax reporting fleet safety and coaching vehicle utilization vehicle inspections vehicle diagnostics messaging driver work flow app market place open
API asset tracking facility insights WIFI hotspot electronic logs vehicle inspections

Messaging
Eld compliance GPS tracking alerts
IFTA fuel tax reporting vehicle utilization vehicle diagnostics driver scorecards
Smart dashcam compatible

Solutions
Video safety GPS tracking eld compliance workflow
7. Dispatcher/broker tracking

Loads that need to be tracked are installed in the system in live time no more a different system for every broker company/driver gives broker/dispatch a code that gives them access. Needs to be able to track the truck and driver.

Cloud Services—Hosting Solution

Internet services experience may vary. Recommended for high speed

Internet use only. Cloud access is supported by most Microsoft remote desktop application clients. May be subject to Microsoft, android, or apple app-store availability.

We recommend a minimum resolution of 1) 1280×768 on RDP portal or 2) 1440×900 on web browser portal. (web access) web browser with html 5 support is required for web access.

Desktop Windows Client
1.4 ghz Intel© Pentium© 4 or faster processor (or equivalent) for Microsoft© Windows© XP or Windows 7; 2 ghz Pentium 4 or faster processor (or equivalent) for Windows Vista©
Windows XP, Windows Vista, Windows 7, Windows 8, or Windows 10 1 gb of ram (2 gb recommended) for Windows XP; 2 gb of ram (4 gb recommended) for Windows 7/Vista, Windows 8 or Windows 10.
50 mb of hard drive space Windows Server
2 ghz Intel© Pentium© 4 or faster processor (or equivalent) Windows XP, Windows Vista, Windows 7, Windows 8, Windows 10. Windows 2003, or Windows Server 2008-2016
2 gb of ram (4 gb recommended)
50 mb of hard drive space for the install and 200+ mb for database. Network
100 mbps or higher wired ethernet network remote/work from home remoting can be provisioned with Citrix© or terminal services provisioned by Microsoft Windows Server

Be advised that some wireless connections do not meet the minimums required to be a true broadband connection. Wireless results may vary.

The following are the specs are recommended for optimum server performance.

These are well above our minimum specs. Recommended

Specs
Processor: Intel Core i7 (quad core) or Xeon
Hard drive: 2 total=1550 (for operation) plus 1 tb. (for storage)
Operating system: Windows 10 or Windows Server 2016 ram memory: 8-16 gb. Lan: gigabit wired connection.

Cloud Services—Hosting Solution

Internet services experience may vary. Recommended for high speed

Internet use only. Cloud access is supported by most Microsoft remote desktop application clients. May be subject to Microsoft, Android, or Apple app-store availability.

We recommend a minimum resolution of 1) 1280×768 on RDP portal or 2) 1440×900 on web browser portal. (web access) web browser with html 5 support is required for web access.

Desktop Windows Client
1.4 ghz Intel© Pentium© 4 or faster processor (or equivalent) for Microsoft© Windows© XP or Windows 7; 2 ghz Pentium 4 or faster processor (or equivalent) for Windows Vista©
Windows XP, Windows vista, Windows 7, Windows 8, or Windows 10 1 gb of ram (2 gb recommended) for Windows XP; 2 gb of ram (4 gb recommended) for Windows 7/vista, Windows 8 or Windows 10.
50 mb of hard drive space Windows Server
2 ghz Intel© Pentium© 4 or faster processor (or equivalent) Windows XP, Windows vista, Windows 7, Windows 8, Windows 10. Windows 2003, or Windows Server 2008-2016
2 gb of ram (4 gb recommended)
50 mb of hard drive space for the install and 200+ mb for database. Network
100 mbps or higher wired ethernet network remote/work from home remoting can be provisioned with Citrix© or terminal services provisioned by Microsoft Windows Server

Be advised that some wireless connections do not meet the minimums required to be a true broadband connection. Wireless results may vary.

The following are the specs are recommended for optimum server performance. These are well above our minimum specs.

Recommended Specs
Processor: Intel Core i7 (quad core) or Xeon
Hard drive: 2 total=1550 (for operation) plus 1 tb. (for storage)
Operating system: Windows 10 or Windows Server 2016 ram memory: 8-16 gb. Lan: gigabit wired connection.

Design Concept—Strive for Consistency.

Consistent sequences of actions should be required in similar situations.

Identical terminology should be used in prompts, menus, and help screens; and consistent commands should be employed throughout.

Enable Frequent Users to Use Shortcuts.

As the frequency of use increases, so do the user's desires to reduce the number of interactions and to increase the pace of interaction.

Abbreviations, function keys, hidden commands, and macro facilities are very helpful to an expert user.

Offer Informative Feedback.

For every operator action, there should be some system feedback. For frequent and minor actions, the response can be modest, while for infrequent and major actions, the response should be more substantial.

Design Dialog to Yield Closure.

Sequences of actions should be organized into groups with a beginning, middle, and end. The informative feedback at the completion of a group of actions gives the operators the satisfaction of accomplishment, a sense of relief, the signal to drop contingency plans and options from their minds, and an indication that the way is clear to prepare for the next group of actions.

Offer Simple Error Handling.

As much as possible, design the system so the user cannot make a serious error. If an error is made, the system should be able to detect the error and offer simple, comprehensible mechanisms for handling the error.

Permit Easy Reversal of Actions.

This feature relieves anxiety, since the user knows that errors can be undone; it thus encourages exploration of unfamiliar options. The units of reversibility may be a single action, a data entry, or a complete group of actions.

Support Internal Locus of Control.

Experienced operators strongly desire the sense that they are in charge of the system and that the system responds to their actions. Design the system to make users the initiators of actions rather than the responders.

Reduce Short-Term Memory Load.

The limitations of human information processing in short-term memory requires that displays be kept simple, multiple page displays be consolidated, window-motion frequency be reduced, and sufficient training time be allotted for codes, mnemonics, and sequences of actions.
I home
Information KIM
Features tour pricing
ELD ELD features
Vehicle inspections messaging
ELD compliance GPS tracking alerts
IFTA fuel tax reporting vehicle utilization
Vehicle diagnostics driver scorecards
Smart dashcam compatible pricing
Electronic-col application cloud-based
Roll up list
Leads applications hires alerts for expiring/incomplete forms/and missing items quick send application to cell phone or email
Visual work history type of application
Quick send
Full application quick app profile for company info driver recruiting
Safety compliance features
Driver qualifications
DQ file maintenance and retention annual MVR review and documentation PSP reports
Daily log auditing
DVIR reconciliation
Accident review and documentation
CSA scorecard review and reconciliation
Data Q system maintenance
Driver manuals
Policies and procedure implementation mock audit
Supervisor safety training quarterly driver safety training 24 hour post-accident testing
Drug & alcohol testing safety training
Forms
Dot physicals—what to bring to your appointment authorization form—dot
Authorization form—non dot
Background investigations authorization form
DER form
Notice of privacy practices patient acknowledgment and consent
Roadside assistance/driver protection semi-truck roadside assistance services
Breakdown assistance jumpstarts
Flat tire changes
Lockout assistance fuel delivery collision assistance 24 hour service
Member-non-member col spouse moving non-moving violations all accidents CSA
Cash bond lawyer
Hotel/car/rental medical/dental, AD&D
Emergency service returns mortal remains
Common commercial roadside assistance services for fleets questions how to avoid rollovers?
How to avoid jackknifing?
Do apus come in all freight and semi-trucks? What's an eld, and what is the eld mandate? How to pass the dot physical for truck drivers?
GPS technology solution to pinpoint breakdown locations in seconds.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A method of managing an electronic driver user profile, the method comprising:
creating a driver briefcase comprising a driver record of a driver;
sending, by a network, the driver record to a cloud network;
updating, at the cloud network, the driver record based upon receiving an indication of an updated driver record by the driver; and
receiving a request, by a third party, for the driver record; and
in response to receiving the request by the third party:
receiving, from the cloud, the driver record.

2. The method of claim 1, wherein the driver record comprises emergency contact information.

3. The method of claim 2, wherein the driver record further comprises a record of all inspections, repairs, and maintenance for a vehicle operated by the driver.

4. The method of claim 3, wherein the request from the third party comprises a request for proof of insurance and an accident register.

5. The method of claim 4, wherein the driver record further comprises a Vehicle Identification Number for the vehicle and a Drivers License Number for the driver.

6. The method of claim 5, further comprising receiving a request, by the third party, for the driver to update the driver record.

7. The method of claim 6, wherein the driver record further comprises a manufacturer recall for the vehicle.

8. The method of claim 7, wherein the driver record further comprises an Application for Employment of the driver.

9. A driver briefcase, comprising:
a driver profile configured to be stored on a cloud network, the driver profile comprising driver information about a driver, and the cloud network accessible by the driver and an administrator; and
the driver information comprising:
point of contact information for the driver;
records of all inspections, repairs, and maintenance relating to a vehicle operated by the driver; and
an accident register.

10. The driver briefcase of claim 9, wherein the driver information can be updated, via the cloud network, by the driver.

11. The driver briefcase of claim 10, wherein a carrier can access the driver profile via the cloud network.

12. The driver briefcase of claim 11, wherein the driver information further comprises insurance information.

13. The driver briefcase of claim 12, wherein the driver information further comprises a record of the quality of previous work by the driver.

14. The driver briefcase of claim 13, further comprising:
proof of driver training on procedures related to fire safety and emergency evacuation.

15. The driver briefcase of claim 14, wherein the driver information includes a Vehicle Identification Number of the vehicle operated by the driver.

16. The driver briefcase of claim 15, wherein the driver information further comprises information about a driver commercial license of the driver.

17. The driver briefcase of claim 16, wherein the driver information further comprises cargo records.

18. The driver briefcase of claim 17, wherein the driver information further comprises a fuel tax log.

19. The driver briefcase of claim 18, further comprising shipment tracking information.
